(19) United States
(12) Patent Application Publication
(10) Pub. No.: US 2003/0228175 A1
(43) Pub. Date: Dec. 11, 2003

(54) AN EJECTION MECHANISM FOR A TONER CONTAINER

(76) Inventors: Jui-Chi Wang, Wu-Chi Town (TW); Robin Hsu, Taichung City (TW); Ren-Hao Liu, Taichung City (TW); Ya-Li Huang, Wu-Chi Town (TW); Xiao Hui Wang, Wu-Chi Town (TW)

Correspondence Address: MERCHANT & GOULD PC, P.O. BOX 2903, MINNEAPOLIS, MN, 55402-0903, US

(21) Appl. No.: 10/199,390

(22) Filed: Jul. 18, 2002

(30) Foreign Application Priority Data
Jun. 11, 2002 (TW) 091208785

(51) Int. Cl. G03G 15/08

(52) U.S. Cl. 399/258; 399/262

(57) ABSTRACT

A toner container is constructed to include a toner storing portion for accommodating toner, a supply opening adapted for guiding toner from the toner storing portion to a toner receiving portion connected to the toner storing portion, a removable sealing member sealing the supply opening, and two elastic members provided at tow sides of the toner storing portion and adapted for pushing the toner storing portion away from the toner receiving portion upon disengagement of the toner storing portion from the toner receiving portion.

### BACKGROUND OF THE INVENTION

1. Field of the Invention

The present invention relates to a toner container for use with a developing device in an image forming apparatus, for example, a copy machine and, more particularly, to an improved structure of toner container.

2. Description of the Related Art

A regular toner container for use with a developing device in a copy machine is generally comprised of a toner storing portion and a toner receiving portion fastened to the toner storing portion for receiving toner from the toner storing portion. The toner storing portion has hooks hooked in respective hook holes in the toner receiving portion. When the toner storing portion unhooked from the toner receiving portion, the toner storing portion is ejected from the toner receiving portion by an ejecting mechanism at the toner receiving portion. This structure of ejecting mechanism wears quickly with use. When the ejecting mechanism starts to wear, it becomes difficult to remove the toner storing portion from the toner receiving portion.

### SUMMARY OF THE INVENTION

The present invention has been accomplished under the circumstances in view. It is the main object of the present invention to provide a toner container, which uses spring members to eject the toner storing portion from the toner receiving portion when the hooks of the toner storing portion disengaged from the respective toner receiving portion. According to the present invention, the toner container comprises a toner storing portion for accommodating toner, a toner receiving portion for receiving toner from the toner storing portion, a supply opening provided in the bottom side of the toner storing portion and adapted for guiding toner from the toner storing portion to the toner receiving portion, a removable sealing member sealing the supply opening, and two elastic members provided at tow sides of the toner storing portion and adapted for pushing the toner storing portion away from the toner receiving portion when unhooked the toner storing portion from the toner receiving portion.

### BRIEF DESCRIPTION OF THE DRAWINGS

FIG. 1 is a perspective exploded view of a toner container according to the present invention.

FIG. 2 is a partial view of an alternate form of the present invention.

FIG. 3 is a partial view of another alternate form of the present invention.

FIG. 4 is a partial view of still another alternate form of the present invention.

### DETAILED DESCRIPTION OF THE PREFERRED EMBODIMENT

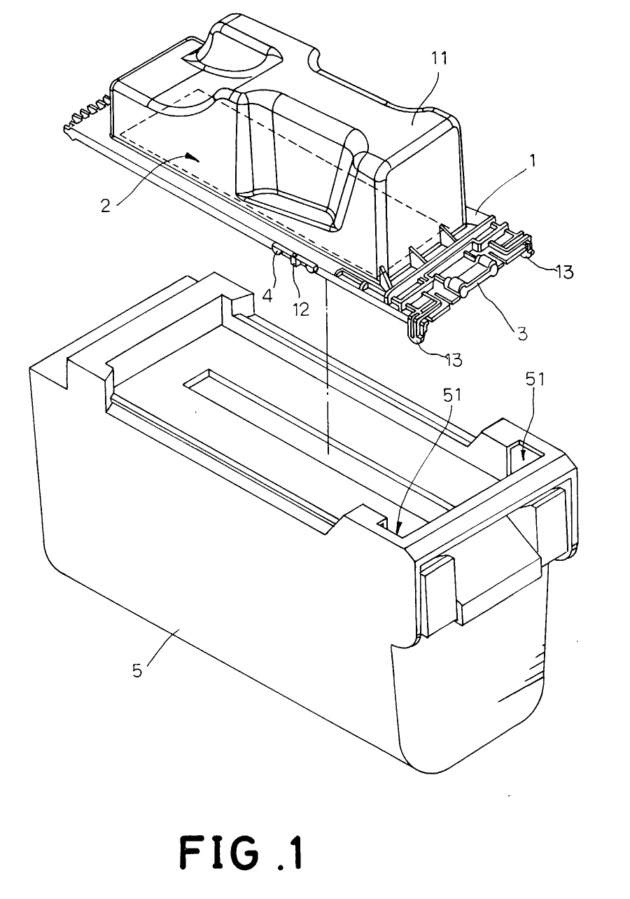

Referring to FIG. 1, a toner container in accordance with the present invention is shown comprised of a toner storing portion 1, a supply opening 2, a removable sealing member 3, elastic members 4, and a toner receiving portion 5.

The toner storing portion 1 is the main body of the toner container, comprising an accumulation chamber 11 adapted for holding toner, two locating blocks 12 disposed at two opposite lateral sides thereof, and two hooks 13 bilaterally downwardly extended from one end thereof and adapted for hooking in respective hook holes 51 in the toner receiving portion 5 to secure the toner storing portion 1 to the toner receiving portion 5. The supply opening 2 is provided in the bottom side (the dotted line shown in FIG. 1) of the toner storing portion 1 and adapted for supplying toner from the accumulation chamber 11 to the toner receiving portion 5. The removable sealing member 3 is fastened to the bottom side of the toner storing portion 1 to seal the supply opening 2. When the removable sealing member 3 removed from the toner storing portion 1, the supply opening 2 is opened, for enabling toner to be supplied from the accumulation chamber 11 to the toner receiving portion 5. The elastic members 4 are fixedly fastened to the locating blocks 12 of the toner storing portion 1. When the toner storing portion 1 fastened to the toner receiving portion 5, the free ends of the elastic members 4 are respectively pressed on the top side of the toner receiving portion 5. After the hooks 13 disengaged from the hook holes 51, the elastic members 4 are released and returned to their former shape to force the toner storing portion 1 upwardly away from the toner receiving portion 5.

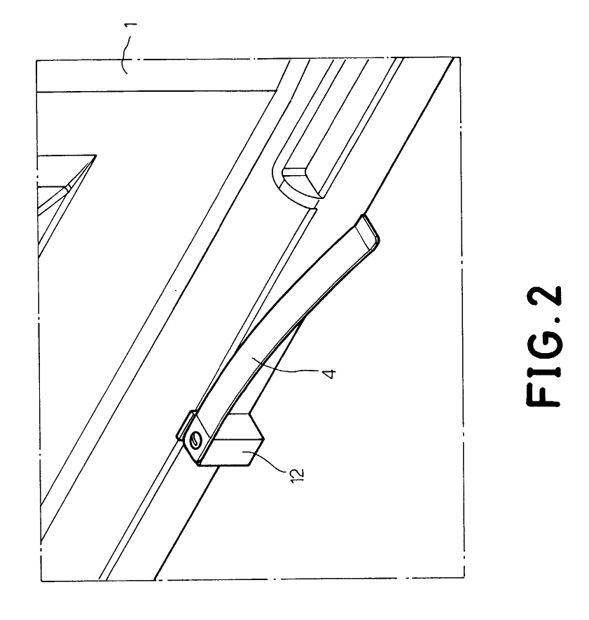

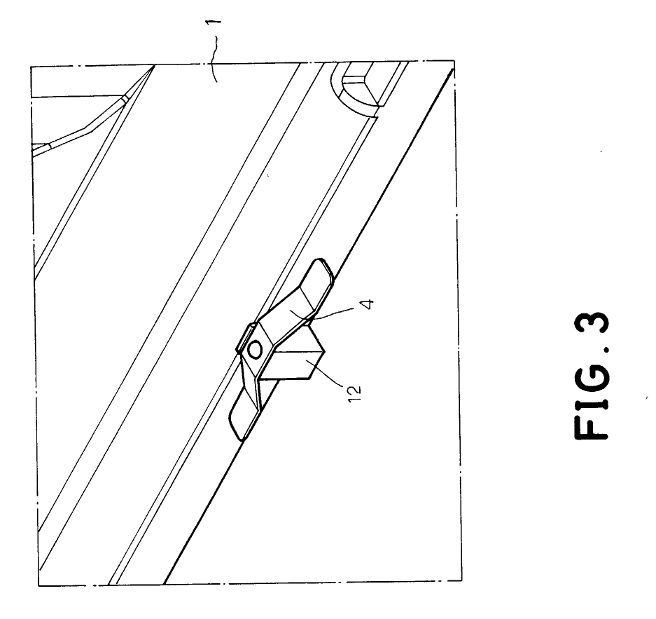

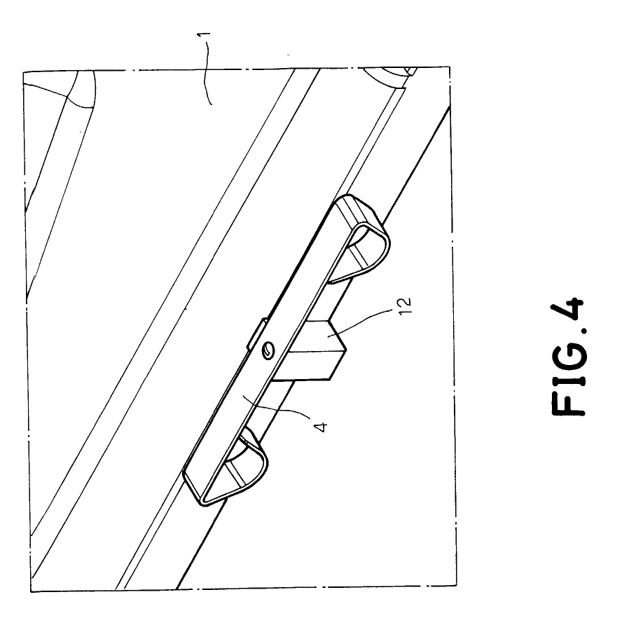

The elastic members 4 may be variously embodied and/or installed in the toner storing portion 1 in any of a variety of forms. For example, the elastic member 4 can be a narrow elongated member fixedly fastened to the corresponding locating block 12 with a screw with one end thereof, leaving the other end thereof free for pressing on the toner receiving portion as shown in FIG. 2; the elastic member 4 can be shaped like an arched member having a middle part riveted to the corresponding locating block 12, leaving the two distal ends thereof free for pressing on the toner receiving portion as shown in FIG. 3; the elastic member can be made having a middle part fixedly fastened to the corresponding locating block 12 with a screw, having the two distal ends thereof turned inwards for pressing on the toner receiving portion as shown in FIG. 4. Further, the elastic member 4 can be made of a spring coil or spring plate, and fastened to the toner storing portion 1 by a glue, hook joint, or the like.

A prototype of toner container has been constructed with the features of FIG. 14. The toner container functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A toner container comprising:
a toner storing portion adapted for accommodating toner for supply toner to a toner receiving portion connected to said toner storing portion;
a supply opening adapted for guiding toner from said toner storing portion to said toner receiving portion;
a removable sealing member fastened to said toner storing portion to close said supply opening; and
at least one elastic member respectively fastened to said toner storing portion and adapted for pushing said toner storing portion away from said toner receiving portion upon disengagement of said toner storing portion from said toner receiving portion.

2. The toner container as claimed in claim 1, wherein said toner storing portion comprises two locating blocks disposed at two sides and adapted for holding said at least one elastic member.

3. The toner container as claimed in claim 1, wherein said at least one elastic member includes two elastic members longitudinally provided at two sides of said toner storing portion.

4. The toner container as claimed in claim 1, wherein said at least one elastic member each is made of a spring plate.

5. The toner container as claimed in claim 1, wherein said at least one elastic member each is formed of a spring coil.

6. The toner container as claimed in claim 1, wherein said at least one elastic member each is respectively fastened to said toner storing portion with screw means.

7. The toner container as claimed in claim 1, wherein said at least one elastic member each is respectively fastened to said toner storing portion with a rivet.

8. The toner container as claimed in claim 1, wherein said at least one elastic member each is respectively fastened to said toner storing portion with a glue.

9. The toner container as claimed in claim 1, wherein said at least one elastic member each is respectively fastened to said toner storing portion by a hook joint.
